(19) United States
(12) Patent Application Publication
(10) Pub. No.: US 2016/0135213 A1
(43) Pub. Date: May 12, 2016

(54) COMMUNICATIONS ASSOCIATED WITH A USER EQUIPMENT CAPABLE OF COMMUNICATING WITH MULTIPLE RADIO ACCESS TECHNOLOGIES

(71) Applicant: QUALCOMM Incorporated, San Diego, CA (US)

(72) Inventors: Xipeng ZHU, Beijing (CN); Jun WANG, San Diego, CA (US); Xiaoxia ZHANG, San Diego, CA (US); Reza SHAHIDI, San Diego, CA (US); Ruiming ZHENG, Beijing (CN); Liangming WU, Beijing (CN)

(21) Appl. No.: 14/308,321

(22) PCT Filed: Jul. 4, 2013
(86) PCT No.: PCT/CN2013/078797

§ 371 Date: Jun. 18, 2014

(51) Int. Cl. H04W 72/12; H04W 24/02

(52) U.S. Cl. CPC H04W 72/1278; H04W 24/02; H04W 88/06

(57) ABSTRACT

Certain aspects of the present disclosure provide a method for wireless communications by a UE. The method generally includes sharing a single transmit chain for communication by at least a first RAT and second RAT, determining a tolerable puncturing rate for the first RAT, and providing assistance information, based on the determined tolerable puncturing rate, to a base station of the second RAT to assist the base station in avoiding scheduling transmissions that would lead to conflict with uplink transmissions in the first RAT. Numerous other aspects are provided.

### CROSS-REFERENCE TO RELATED APPLICATIONS

This application claims benefit of priority to PCT/CN2013/078797, filed Jul. 4, 2013, which is expressly incorporated herein by reference in its entirety.

### BACKGROUND

1. Field

Aspects of the present disclosure relate generally to wireless communications, and more particularly, to improving communications associated with a user equipment capable of communicating with multiple radio access technologies (e.g., techniques for transmitter sharing by a user equipment (UE) for simultaneous communications between multiple radio access technology (RAT) networks).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. These improvements should be applicable to other multi-access technologies and the telecommunication standards that employ these technologies.

### SUMMARY

Certain aspects of the present disclosure provide a method for wireless communications by a user equipment (UE). The method generally includes sharing a single transmit chain for communication by at least a first radio access technology (RAT) and second RAT, determining a tolerable puncturing rate for the first RAT, and providing assistance information, based on the determined tolerable puncturing rate, to a base station of the second RAT to assist the base station in avoiding scheduling transmissions that would lead to conflict with uplink transmissions in the first RAT.

Certain aspects of the present disclosure provide a method for wireless communications by a user equipment (UE). The method generally includes sharing a single transmit chain and a single receive chain for communication by at least a first radio access technology (RAT) and a second RAT, and providing assistance information to a base station of the second RAT to assist the BS in avoiding scheduling downlink transmissions that would lead to conflict with the UE receiving one or more pages in the first RAT, wherein the assistance information comprises an indication of one or more paging occurrences in the first RAT and wherein the indication is provided in terms of Global Systems for Mobile Communications (GSM) discontinuous transmission (DRX) and long-term evolution (LTE) system frame number (SFN)+LTE subframe number associated with a next GSM page time.

Certain aspects of the present disclosure provide a method for wireless communications by a base station (BS). The method generally includes obtaining a tolerable puncturing rate for a first radio access technology (RAT), and based at least in part on the tolerable puncturing rate, scheduling uplink transmissions for a user equipment (UE) in an effort to avoid uplink transmissions that conflict with uplink transmissions from the UE in the first RAT.

Certain aspects of the present disclosure provide a method for wireless communications by a user equipment (UE) capable of communicating via at least a first radio access technology (RAT) and second RAT. The method generally includes identifying one or more frequency ranges on which communications in the first RAT interfere or potentially interfere with communications in the second RAT, and reporting an indication of physical resource blocks (PRBs) corresponding to the identified frequency ranges to a base station (BS) of the second RAT.

Certain aspects of the present disclosure provide a method for wireless communications by a base station (BS) of a second radio access technology (RAT) for communicating with a user equipment (UE) capable of communicating via at least a first RAT and the second RAT. The method generally includes identifying physical resource blocks (PRBs) corresponding to one or more frequency ranges on which uplink transmissions by the UE in the first RAT interfere or potentially interfere with downlink transmissions in the first or second RAT, and causing uplink transmissions from the UE to the BS to avoid using the identified physical resource blocks (PRBs).

Aspects generally include methods, apparatus, systems, computer program products, and processing systems, as substantially described herein with reference to and as illustrated by the accompanying drawings.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary deployment in which multiple wireless networks have overlapping coverage.

FIG. 2 illustrates a block diagram of a user equipment (UE) and other network entities.

FIG. 3 illustrates an example IDC procedure, in accordance with certain aspects of the present disclosure.

FIGS. 4-8 illustrate example operations performed in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1× radio transmission technology (1×RTT), CDMA2000 1×, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

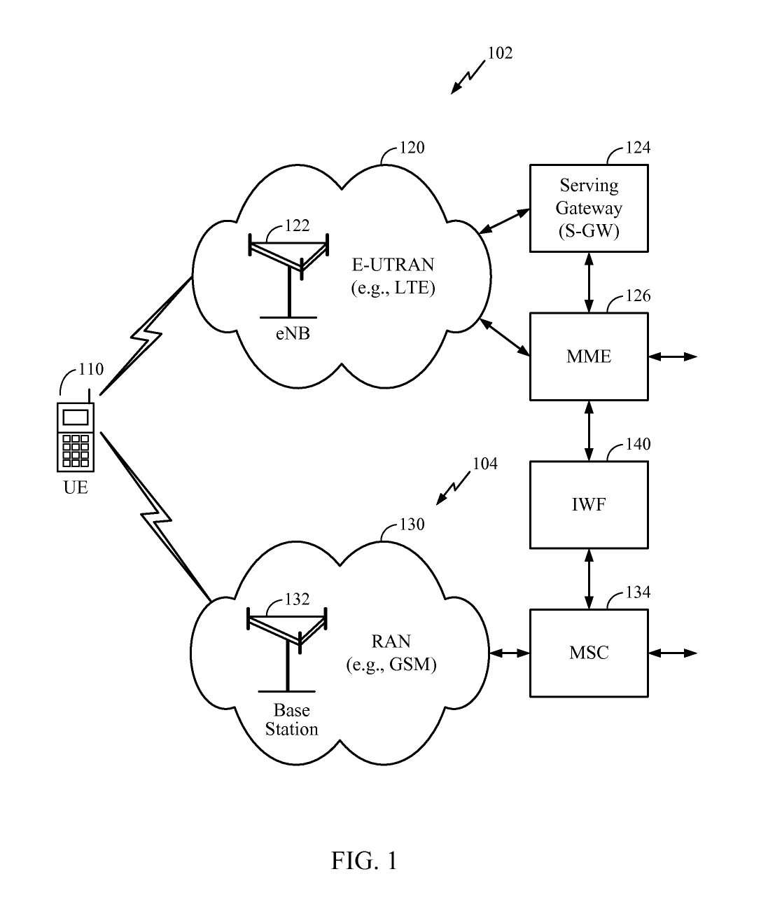

FIG. 1 shows an exemplary deployment in which multiple wireless networks have overlapping coverage. An evolved universal terrestrial radio access network (E-UTRAN) 120 may support LTE and may include a number of evolved Node Bs (eNBs) 122 and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1×CSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency or frequency ranges may also be referred to as a carrier, a frequency channel, etc. Each frequency or frequency ranges may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y, and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1×RTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

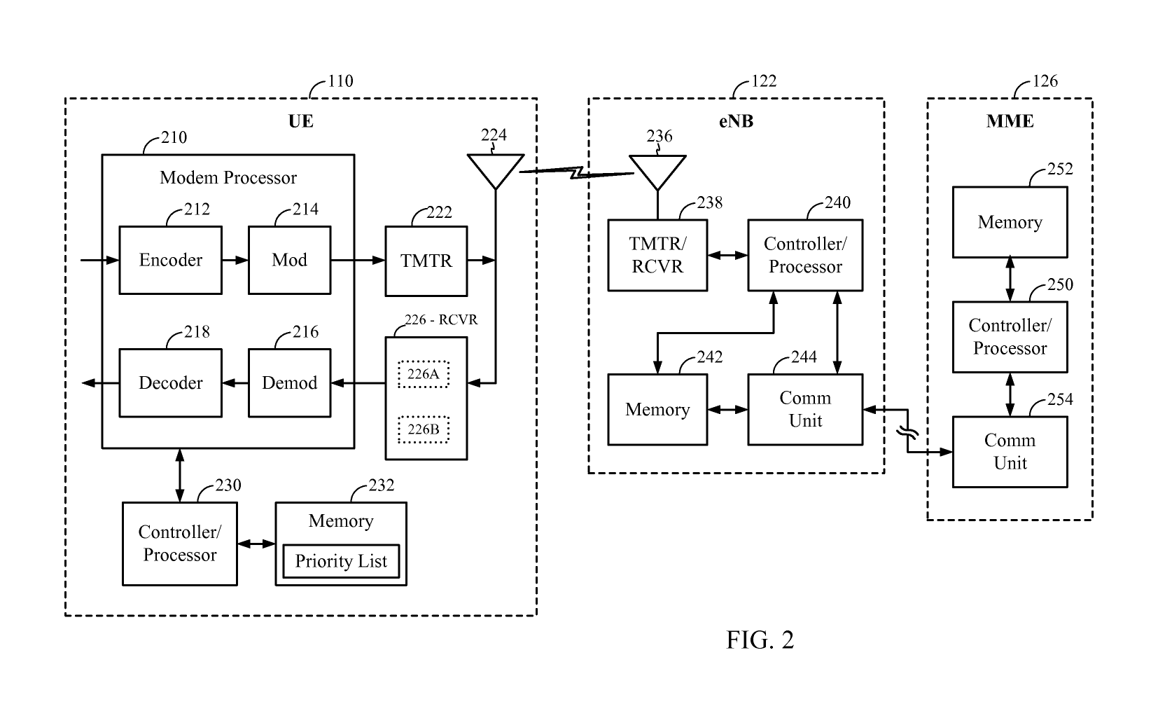

FIG. 2 shows a block diagram of a design of UE 110, eNB 122, and MME 126 in FIG. 1. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210, for example. These units may perform processing in accordance with the RAT (e.g., LTE, GSM, 1×RTT, etc.) used by the wireless network with which UE 110 is in communication.

According to aspects, as will be described in more details herein, the UE 110 may support communications with multiple RATs (e.g., concurrent RATs) (CRAT). The CRAT UE may share uplink transmissions between two RATs (e.g., transmit sharing), for example, in terms of TDM. The CRAT UE may support dual receiving of downlink transmissions.

A controller/processor 230 may direct the operation at UE 110. Controller/processor 230 may also perform or direct other processes for the techniques described herein. In aspects, one or more of any of the components of the UE 110 may be employed to perform example operations 400, 500, 700 and/or other processes for the techniques described herein. Memory 232 may store program codes and data for UE 110. Memory 232 may also store a priority list and configuration information.

At eNB 122, a transmitter/receiver 238 may support radio communication with UE 110 and/or other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and/or other UEs. Controller/processor 240 may also perform or direct other processes for the techniques described herein. In aspects, one or more of any of the components of the eNB 122 may be employed to perform example operations 600, 800 and/or other processes for the techniques described herein. However, any component shown in FIG. 1 (e.g., base station 132) may perform example operations 600, 800 and/or other processes for the techniques described herein. Memory 242 may store program codes and data for the base station. A communication (Comm) unit 244 may support communication with MME 126 and/or other network entities.

At MME 126, a controller/processor 250 may perform various functions to support communication services for UEs. Memory 252 may store program codes and data for MME 126. A communication unit 254 may support communication with other network entities.

FIG. 2 shows simplified designs of UE 110, eNB 122, and MME 126. In general, each entity may include any number of transmitters, receivers, processors, controllers, memories, communication units, etc. Other network entities may also be implemented in similar manner.

For example, UE 110 of FIG. 2 comprises a single TMTR 222 and a single RCVR 226. According to aspects, UE 110 may comprise a single TMTR and a dual RCVR (e.g., 226a, 226b), and therefore may support CRAT. For example, UE 110 may share uplink transmissions between two RATs using a single transmitter and may support dual downlink receiving. According to aspects, the UE may support CRAT with LTE and Global Systems for Mobile Communications (GSM) or CDMA2000 1×RTT.

One challenge with utilizing a single transmitter for concurrent communications is that, at times, there may be conflicts between scheduled uplink transmissions in both RATs. While the conflict may occur with an uplink transmission, the uplink transmission itself may result from a scheduled downlink transmission. For example, for scheduled LTE downlink transmissions, a UE may need to transmit an uplink ACK to confirm the UE received the data. In other words, it is possible that a UE may be, problematically, scheduled for uplink transmission in both RATs during given a transmission period.

In some cases, reception with multiple RATs (e.g., concurrent Rx) may also be achieved. For example, two RCVRs (e.g., two separate receive chains with two separate antennas) may be shared by GSM or CDMA2000 1×RTT, and LTE in a manner similar to Simultaneous Hybrid Dual Receivers (SHDR). When GSM or CDMA2000 1×RTT receiving is not needed, LTE may use two receive chains for multiple input multiple output (MIMO) and diversity. When GSM or CDMA2000 1×RTT receiving is needed, one RCVR may be tuned to GSM or CDMA2000 1×RTT, and the remaining RCVR may be used for LTE receiving. In some embodiments, since only one receive chain is being used for LTE, the UE may report a fake channel quality indictor (CQI) to avoid eNB scheduling for dual layer transmission.

### Improving Communications Associated with a User Equipment Capable of Communicating with Multiple Radio Access Technologies

As described above with reference to FIGS. 1 and 2, a UE supporting CRAT may share a single transmit chain between two RATs while supporting dual downlink reception. The UE may share uplink transmissions in terms of TDM.

Three use cases for a CRAT UE are described herein. First, a CRAT UE may support (e.g., concurrent) GSM/CDMA2000 1×RTT voice and LTE data using a dual receiver single radio LTE (SRLTE). Second, a CRAT UE may avoid RF coexistence issue including, for example, inter-modulation (IM). Third, a CRAT UE may support (e.g., concurrent) signaling and voice/data using a dual receiver dual SIM dual standby (DSDS).

As will be described in more detail herein, to support CRAT operations, the UE may report assistance information to the network, in an effort to allow the network to avoid scheduling potential uplink transmission collisions. According to aspects, the UE may puncture (e.g., ignore) uplink transmissions from one RAT when an uplink transmission conflict exists. Additionally, the network may avoid scheduling potential uplink transmission collisions based, at least in part, on information collected by the network (e.g., by using inter-eNB-base station controller (BSC) interface).

The following paragraphs provide a few technical points regarding transmit sharing for a CRAT UE. Aspects include how to achieve a dual receiver, synchronized HARQ on the uplink, and transmit switching time.

### Achieving Dual Receiver

UE 110 may use transmit sharing to support CRAT operations. Transmit sharing requires a dual receiver, however existing SRLTE/1×SRLTE devices have only one receiver. Thus, an LTE carrier aggregation (CA) platform may be supported by the UE. According to this option, the UE may tune the receiver of one component carrier (CC) to 1×/GSM when listening for 1×/GSM. When CA is enabled, the UE may report a bad channel quality information (CQI) (e.g., a degraded CQI) to the LTE eNB for the CC before and/or during the time in which the receiver is tuned away to 1×/GSM. Reporting a degraded CQI may cause the LTE eNB to avoid scheduling uplink transmissions on the CC for the UE.

### Synchronized HARQ on UL

Since LTE uses synchronized HARQ on the UL, the UL slot for re-transmission may conflict with GSM/1× UL transmissions for a CRAT UE. According to aspects, when an LTE eNB predicts that the UL re-transmission may not be possible, the eNB may schedule a low modulation and coding scheme (MCS) and/or may send an acknowledgment (ACK) (e.g., regardless of whether the transmission was successfully received) to the UE in an effort to avoid the re-transmission. According to aspects, due to the CRAT UE's single transmitter, when the eNB does not transmit an acknowledgment, the UE may skip the UL re-transmission opportunity, or the UE may skip the GSM/1× transmission.

### TX Switching Time

Tuning the CRAT UE between GSM/1× and LTE may require 1 ms or more, which includes tuning circuitry, such as the local oscillator (LO) and/or phase lock loop (PLL), from the UL transmit frequency of one RAT to another RAT. The tuning time may also include time for register updates. According to aspects, the CRAT UE may include two independent circuitry (e.g., LOs and/or PLLs) for UL transmission for the two RATs, in an effort to avoid LO/PLL tuning in transmit switching. In addition, the CRAT UE may maintain one or more portions of such circuitry (e.g., baseband side interfaces (e.g., digital to analog converter (DAC))) of the two RATs active.

### UE Assisted Transmit Sharing

In an effort to support UE assisted transmit sharing for a dual receiver 1×SRLTE, according to aspects, the UE may estimate the tolerable GSM/CDMA2000 1× puncturing rate. The puncturing rate may be estimated based on short term statistics of acknowledgment for UL frame early termination (FET), if 1× advanced is supported, or 1× power headroom, if 1× advanced is not supported.

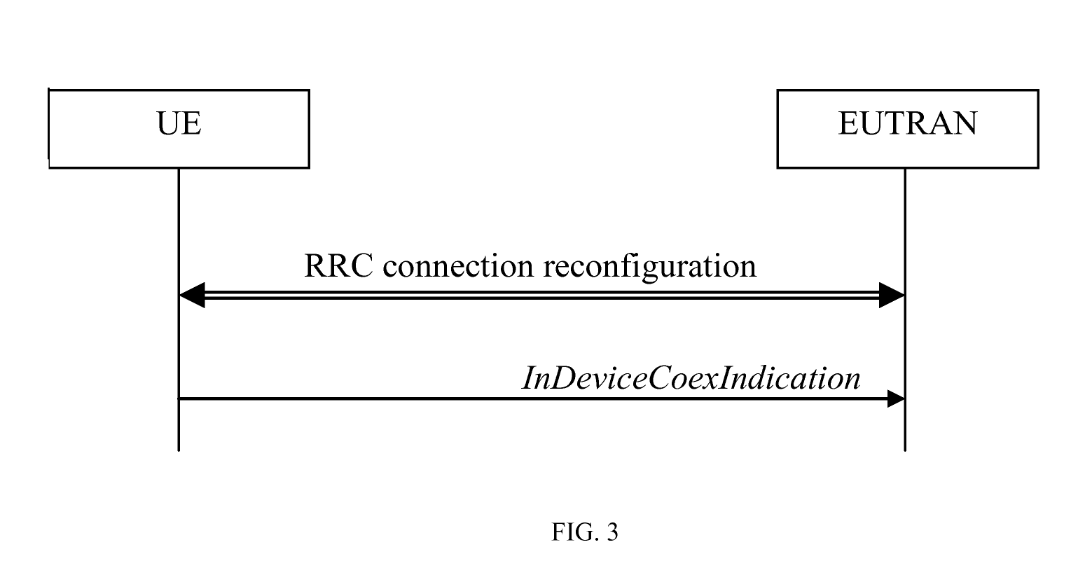

FIG. 3 illustrates an example in-device coexistence (IDC) indication procedure. As shown in FIG. 3, a UE, such as CRAT UE 110 if FIG. 1, may provide an IDC indication to the eNB. In the IDC indication sent by the UE to the eNB, the UE may inform E-UTRAN about IDC problems. For example, the CRAT UE may determine an in-device coexistence subframe pattern per tolerable puncturing rate, and may report it to the eNB in the IDC indicator.

IDC enables the LTE network to avoid interference with another RAT in terms of TDM by smart scheduling based on the assistance information received from the UE. The UE may report, for example, the following IDC subframe pattern to eNB.

| | |
|---|---|
| subframePatternFDD-r11 | BIT STRING (SIZE (40)), |
| subframePatternTDD-r11 | Choice of: |
| subframeConfig0-r11 | BIT STRING (SIZE (70)), |
| subframeConfig1-5-r11 | BIT STRING (SIZE (10)), |
| subframeConfig6-r11 | BIT STRING (SIZE (60)) |

A bit in a subframe pattern set to 0 indicates that the eNB should not schedule transmission at that subframe. Such a subframe pattern may repeat until the UE transmits an updated pattern, as channel conditions and voice packet type changes may be slow.

As an alternative to the CRAT UE transmitting an IDC indication, according to another aspect, to support UE assisted transmit sharing for dual receiver 1×SRLTE, the CRAT UE may report a tolerable 1× puncturing rate to the eNB directly, instead of the subframe pattern. This approach may be associated with an IDC standard change or a MAC control element (CE) based solution. In aspects, the MAC CE may be identifiable by a Logical Channel ID (LCID). In aspects, a reserved LCID may be used to identify a new MAC CE.

When an uplink conflict may not be avoided, the CRAT UE may puncture GSM/CDMA2000 1×UL transmissions that conflict with LTE UL transmissions. In an attempt to compensate for the transmission time loss, the UE may increase the transmission power of the GSM/CDMA2000 1× transmission (e.g., autonomously) by adding a fixed power offset or adding a variable power offset, taking into account the puncturing percentage, channels status, and/or channel coding. If the UE does not have sufficient power headroom to afford the puncturing, the conflicting LTE UL transmission may be skipped.

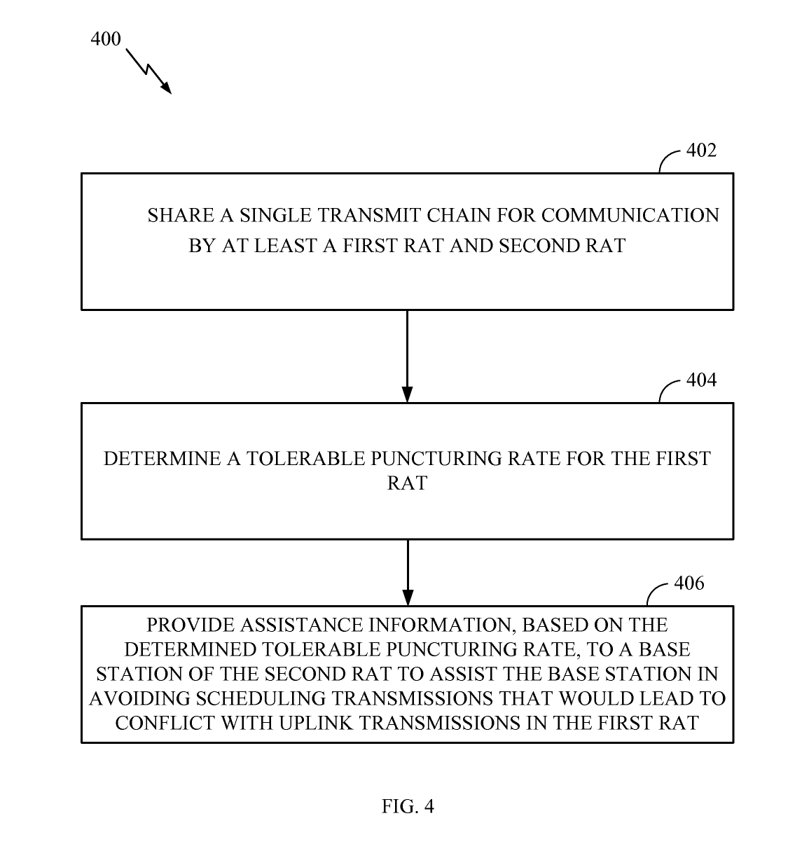

FIG. 4 illustrates example operations 400 performed, for example, by a UE, according to aspects of the present disclosure. At 402, the UE may share a single transmit chain for communication by at least a first radio access technology (RAT) and second RAT. At 404, the UE may determine a tolerable puncturing rate for the first RAT. At 406, the UE may provide assistance information, based on the determined tolerable puncturing rate, to a base station of the second RAT to assist the base station in avoiding scheduling transmissions that would lead to conflict with uplink transmissions in the first RAT. According to aspects, the assistance information may include the tolerable puncturing rate.

As described above, the first RAT may include GSM or CDMA2000 1×RTT and the second RAT may include LTE. The assistance information may be provided as a pattern of bits, each bit indicating whether or not the base station should schedule an uplink transmission in a corresponding subframe.

The UE may further determine one or more scheduled transmissions in the first RAT may lead to conflict with one or more scheduled uplink transmissions in the second RAT. In response, the UE may puncture data in the one or more scheduled uplink transmissions in the first RAT or may skip a scheduled transmission in the second RAT. The UE may compensate for puncturing by increasing transmission power for the punctured uplink transmissions in the first RAT.

The UE may employ a first tuning circuitry for transmission on a frequency associated with the first RAT and may employ a second tuning circuitry for transmission on a frequency associated with the second RAT. The UE may further maintain one or more portions of the first tuning circuitry and second tuning circuitry active.

According to aspects, a UE may provide an indication of a paging occurrence in GSM/CDMA2000 1× to the LTE BS in terms of LTE system frame number (SFN)+LTE subframe number (SF) and GSM discontinuous reception (DRX).

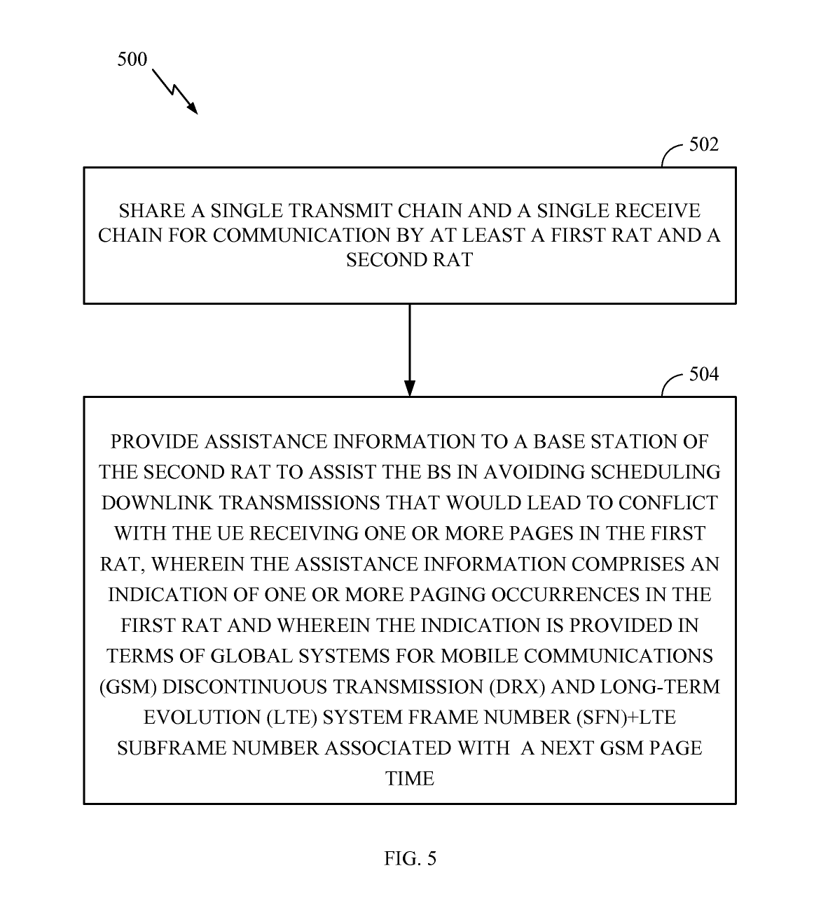

FIG. 5 illustrates example operations 500 that may be performed by a UE, according to aspects of the present disclosure. At 502, a UE may share a single transmit chain and a single receive chain for communication by at least a first radio access technology (RAT) and a second RAT. At 504, the UE may provide assistance information to a base station of the second RAT to assist the BS in avoiding scheduling downlink transmissions that would lead to conflict with the UE receiving one or more pages in the first RAT.

As described above, the assistance information may comprise an indication of one or more paging occurrences in the first RAT and wherein the indication is provided in terms of Global Systems for Mobile Communications (GSM) discontinuous transmission (DRX) and long-term evolution (LTE) system frame number (SFN)+LTE subframe number of a next GSM page (e.g., associated with a next GSM page time).

The assistance information may be provided in a MAC control element. The first RAT may include GSM and the second RAT may include LTE.

### Network Based Approach

According to aspects, the network (e.g., an entity included therein such as a RNC/BSC) may send assistance information the eNB. For 1×SRLTE, the eNB may schedule uplink and downlink transmission per tolerable 1× puncturing rate. The eNB may derive the tolerable puncturing rate from the 1×BTS/BSC according to one of two options. According to a first option, the 1×BTS/BSC may report the block error rate (BLER) (or early termination time if 1× advanced is supported, for example) to the eNB. According to a second option, the 1×BTS/BSC may send an estimated tolerable puncturing rate to the eNB. Both of these options may employ an interface between 1×BTS/BSC and the eNB. Additionally, routine information mobility (RIM) may need to be enhanced in an effort to support assistance information delivery to the eNB.

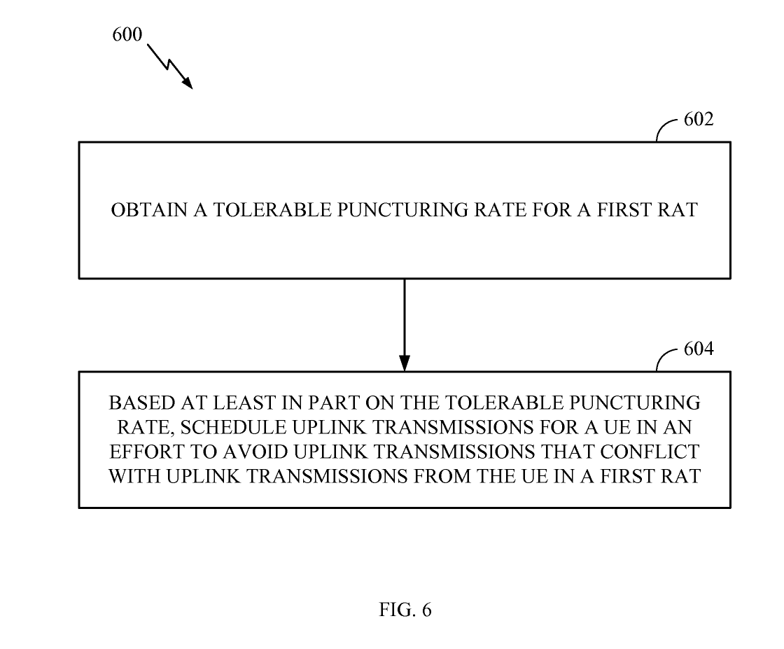

FIG. 6 illustrates example operations 600 that may be performed by a BS of a second RAT, according to aspects of the present disclosure. At 602, the BS may obtain a tolerable puncturing rate for a first RAT. At 604, based at least in part on the tolerable puncturing rate, the BS may schedule uplink transmissions for a UE in an effort to avoid uplink transmissions that conflict with uplink transmissions from the UE in the first RAT.

As described herein the first RAT may include GSM or CDMA2000 1×RTT, and the second RAT may include LTE. The BS may obtain the tolerable puncturing rate by receiving an indication of the tolerable puncturing rate from the UE or via a network associated with the BS. According to aspects, the BS may derive the tolerable puncturing rate.

### UE Assisted FDM

A simultaneous GSM and LTE (SGLTE) UE is registered on GSM/CDMA2000 1×RTT CS and LTE PS (e.g., in parallel). SGLTE allows concurrent CS and PS after CSFB is deployed. Notably, FDM for avoiding RF coexistence issues for a dual radio UE relates to interference avoidance (e.g., as opposed to transmit sharing). According to aspects, in an effort to avoid interference, the UE may identify LTE related RF issues and may report the affected resources, such as physical resource blocks (PRBs) or frequency range information, to the BS. The UE may report such information using a new parameter of IDC and/or using sub-band CQI, as explained in more detail below.

Existing IDC supports a UE reporting affected LTE carrier frequency lists to BS in an effort for the BS to avoid the interference by, for example, ensuring the UE is not handed over to the affected carrier. According to aspects of the present disclosure, enhanced IDC signaling, may be used for the UE to report affected PRB list information to the BS. An example of the enhanced IDC signaling is shown below in bold, wherein the UE may signal the affected PRB list to the eNB.

InDeviceCoexIndication-r11-IEs ::= SEQUENCE {

| | | |
|---|---|---|
| affectedCarrierFreqList- | AffectedCarrierFreqList- | OPTIONAL, |
| r11 | r11 | |
| affectedPRBlist | AffectedPRBlist | OPTIONAL |
| tdm-AssistanceInfo-r11 | TDM-AssistanceInfo-r11 | OPTIONAL, |
| lateNonCriticalExtension | OCTET STRING | OPTIONAL, |
| nonCriticalExtension | SEQUENCE { } | OPTIONAL} |

As mentioned above, the UE may report affected PRBs or frequency range information to the BS using sub-band CQI. According to this option, the UE may report bad CQI values (e.g., degraded CQI values, such as CQI=0) for corresponding sub-bands. According to another option, the affected PRBs may be excluded by the UE in sub-band CQI reporting.

The CQI reporting mode is configured by RRC signaling (e.g., in cqi-FormatIndicatorPeriodic) as one or more of wideband CQI, High Layer configured sub-band CQI, and UE-selected sub-band CQI.

For higher-layer configured sub-band CQI, which may be reported in a PUSCH, the UE may report one sub-band CQI value for each sub-band. The UE may report a bad CQI (e.g., degraded) CQI value on the sub-band which includes the affected PRB, in an effort to avoid scheduling by the eNB.

For UE-selected sub-band CQI may include aperiodic PUSCH reports and periodic PUCCH reports. For aperiodic PUSCH reporting, the UE may select sets of M preferred sub-bands within the set of S sub-band and may report one CQI reflecting transmission over the M selected sub-bands. The UE reports the positions of the M selected sub-bands using a combinatorial index r as defined in TS36.213 section 7.2.1.

For periodic PUCCH reporting, the UE selects the preferred the sub-band within the set of Nⱼ sub-bands in each of j bandwidth parts. The UE reports one CQI reflecting the transmission only over the selected sub-band of the bandwidth parts.

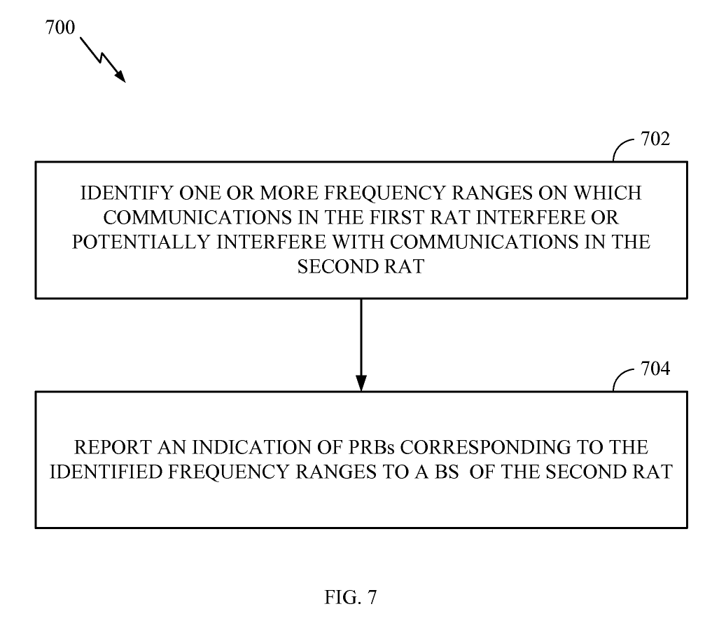

FIG. 7 illustrates example operations 700 that may be performed, for example, by a UE capable of communicating via at least a first RAT and second RAT, according to aspects of the present disclosure. At 702, the UE may identify one or more frequency ranges on which communications in the first RAT interfere or potentially interfere with communications in the second RAT. At 704, the UE may report an indication of PRBs corresponding to the identified frequency ranges to a base station (BS) of the second RAT.

The first RAT may include GSM or CDMA2000 1×RTT and the second RAT may include LTE. As described above, the UE may report the indication of the PRBs using an in-device coexistence (IDC) parameter.

According to aspects, the UE may report a degraded CQI for the PRBs corresponding to the identified frequency ranges. CQIs corresponding to the PRBs of the identified frequency ranges may be excluded from the CQI reported to the BS.

The UE may employ a first tuning circuitry for transmission on a frequency associated with the first RAT and may employ a second tuning circuitry for transmission on a frequency associated with the second RAT. The UE may further maintain one or more portions of the first tuning circuitry and second tuning circuitry active.

### Network Based FDM

As described above, a SGLTE UE is registered on GSM/CDMA2000 1×RTT CS and LTE PS (e.g., in parallel). SGLTE allows concurrent CS and PS after CSFB is deployed. Notably, FDM for avoiding RF coexistence issues for a dual radio UE relates to interference avoidance (e.g., as opposed to transmit sharing). From a network perspective, the eNB may know or guess a UE's serving GSM/1×/UMTS frequency using one or more neighbor lists.

The eNB may know the UE type (e.g., that the UE is a dual subscriber identity module, dual active (DSDA)/single subscriber identity module, dual active (SSDA) UE, etc.) using one of a number of approaches. For example, the eNB may use the International Mobile Equipment Identify (IMEI), IMEI Software Version (IMEISV), and/or device identity. The eNB may know the UE is a DSDA/SSDA UE using new parameters in UE radio capability. Additionally or alternatively, existing parameters, such as the below parameters indicating Simultaneous Voice and LTE (SVLTE) may be used.

| | |
|---|---|
| IRAT-ParametersCDMA2000-1XRTT ::= | SEQUENCE { |
| supportedBandList1XRTT | SupportedBandList1XRTT, |
| tx-Config1XRTT | ENUMERATED |
| | {single, dual}, |
| rx-Config1XRTT | ENUMERATED |
| | {single, dual} |

The eNB may predict RF issues per serving GSM/1×/UMTS band and UE-type information. With the predicted RF issues, the eNB may attempt to avoid the issues through scheduling and/or mobility. For example, the eNB may not schedule transmissions to the UE on affected PRBs. Regarding mobility, the eNB may handover/redirect the UE to a frequency or RAT not affected by the potential RF issue.

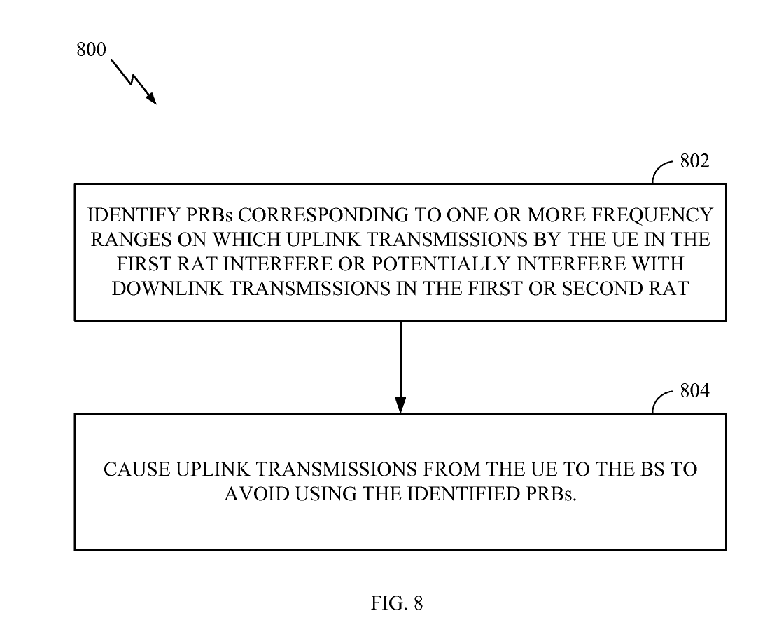

FIG. 8 illustrates operations 800 that may be performed, for example, by a BS of a second RAT for communicating with UE capable of communicating via at least a first RAT and the second RAT. AT 802, the BS may identify physical resource blocks (PRBs) corresponding to one or more frequency ranges on which uplink transmissions by the UE in the first RAT interfere or potentially interfere downlink transmissions in the first or second RAT. At 804, the BS may cause uplink transmissions from the UE to the BS to avoid using the identified PRBs.

The first RAT may include GSM or CDMA2000 1×RTT, and the second RAT may include LTE. Alternatively, the first RAT may include LTE, and the second RAT may include GSM or CDMA2000 1×RTT. Causing uplink transmissions from the UE to the BS to avoid using the identified PRBs may include scheduling uplink transmissions from the UE in an effort to avoid using the identified PRBs. The scheduling may include scheduling uplink transmissions from the UE on PRBs not corresponding to one or more frequency ranges on which UL transmission by the UE in the first RAT interfere or potentially interfere with downlink receiving from either the second RAT or the first RAT, or initiating a handover to a RAT or frequency on which communications by the UE in the first RAT do not interfere with communications in the second RAT.

Causing uplink transmissions from the UE to the BS to avoid using the identified PRBs may include transmitting an acknowledgment message (ACK) to the UE to prevent an uplink transmission from the UE.

As described above, the identification of PRBs may include predicting one or more frequencies used by the first RAT serving the UE based on neighbor frequency lists and/or a UE type.

Several aspects of a telecommunications system has been presented with reference to a GSM, 1×, and LTE system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications by a user equipment (UE), comprising:
sharing a single transmit chain for communication by at least a first radio access technology (RAT) and second RAT;
determining a tolerable puncturing rate for the first RAT; and
providing assistance information, based on the determined tolerable puncturing rate, to a base station of the second RAT to assist the base station in avoiding scheduling transmissions that would lead to conflict with uplink transmissions in the first RAT.

2. The method of claim 1, wherein the second RAT comprises long-term evolution (LTE).

3. The method of claim 2, wherein the first RAT comprises Global Systems for Mobile Communications (GSM) or CDMA2000 1×RTT.

4. The method of claim 1, wherein the assistance information is provided as a pattern of bits, each bit indicating whether or not the base station should schedule an uplink transmission in a corresponding subframe.

5. The method of claim 1, wherein the assistance information comprises the determined tolerable puncturing rate.

6. The method of claim 1, further comprising:
determining one or more scheduled transmissions in the first RAT would lead to conflict with one or more scheduled uplink transmissions in the second RAT; and
in response to the determination, at least one of puncturing data in the one or more scheduled uplink transmissions in the first RAT or skipping a scheduled transmission in the second RAT.

7. The method of claim 6, further comprising compensating for the puncturing by increasing transmission power for the punctured uplink transmissions in the first RAT.

8. The method of claim 1, wherein the assistance information is provided in a media access control (MAC) control element.

9. The method of claim 1, further comprising:
employing first tuning circuitry for transmission on a frequency associated with the first RAT; and
employing second tuning circuitry for transmission on a frequency associated with the second RAT.

10. The method of claim 9, further comprising maintaining one or more portions of the first tuning circuitry and second tuning circuitry active.

11. A method of wireless communications by a user equipment (UE), comprising:
sharing a single transmit chain and a single receive chain for communication by at least a first radio access technology (RAT) and a second RAT; and
providing assistance information to a base station of the second RAT to assist the BS in avoiding scheduling downlink transmissions that would lead to conflict with the UE receiving one or more pages in the first RAT,
wherein the assistance information comprises an indication of one or more paging occurrences in the first RAT and wherein the indication is provided in terms of Global Systems for Mobile Communications (GSM) discontinuous transmission (DRX) and long-term evolution (LTE) system frame number (SFN)+LTE subframe number associated with a next GSM page time.

12. The method of claim 11, wherein the assistance information is provided in a media access control (MAC) control element.

13. The method of claim 11, wherein the second RAT comprises long-term evolution (LTE).

14. The method of claim 13, wherein the first RAT comprises Global Systems for Mobile Communications (GSM).

15. A method for wireless communications by a base station (BS) of a second radio access technology (RAT), comprising:
obtaining a tolerable puncturing rate for a first radio access technology (RAT); and
based at least in part on the tolerable puncturing rate, scheduling uplink transmissions for a user equipment (UE) in an effort to avoid uplink transmissions that conflict with uplink transmissions from the UE in the first RAT.

16. The method of claim 15, wherein the second RAT comprises long-term evolution (LTE).

17. The method of claim 16, wherein the first RAT comprises Global Systems for Mobile Communications (GSM) or CDMA2000 1×RTT.

18. The method of claim 15, wherein obtaining the tolerable puncturing rate comprises receiving an indication of the tolerable puncturing rate from the UE.

19. The method of claim 15, wherein obtaining the tolerable puncturing rate comprises deriving the tolerable puncturing rate.

20. The method of claim 15, wherein obtaining the tolerable puncturing rate comprises receiving an indication of the tolerable puncturing rate via a network associated with the BS.

21. A method for wireless communications by a user equipment (UE) capable of communicating via at least a first radio access technology (RAT) and second RAT, comprising:
identifying one or more frequency ranges on which communications in the first RAT interfere or potentially interfere with communications in the second RAT; and
reporting an indication of physical resource blocks (PRBs) corresponding to the identified frequency ranges to a base station (BS) of the second RAT.

22. The method of claim 21, wherein the second RAT comprises long-term evolution (LTE).

23. The method of claim 22, wherein the first RAT comprises Global Systems for Mobile Communications (GSM) or CDMA2000 1×RTT.

24. The method of claim 21, wherein the UE reports the indication of the PRBs using an in-device coexistence (IDC) parameter.

25. The method of claim 21, wherein the reporting includes reporting degraded channel quality information (CQI) for the PRBs.

26. The method of claim 21, wherein channel quality information (CQI) corresponding to the PRBs is excluded from the CQI reported to the BS.

27. The method of claim 21, further comprising:
employing first tuning circuitry for transmission on a frequency associated with the first RAT; and
employing second tuning circuitry for transmission on a frequency associated with the second RAT.

28. The method of claim 27, further comprising maintaining one or more portions of the first tuning circuitry and second tuning circuitry active.

29. A method for wireless communications by a base station (BS) of a second radio access technology (RAT) for communicating with a user equipment (UE) capable of communicating via at least a first RAT and the second RAT, comprising:
identifying physical resource blocks (PRBs) corresponding to one or more frequency ranges on which uplink transmissions by the UE in the first RAT interfere or potentially interfere with downlink transmissions in the first or second RAT; and
causing uplink transmissions from the UE to the BS to avoid using the identified physical resource blocks (PRBs).

30. The method of claim 29, wherein causing uplink transmissions from the UE to the BS to avoid using the identified PRBs includes scheduling uplink transmissions from the UE in an effort to avoid using the identified physical resource blocks (PRBs).

31. The method of claim 29, wherein causing uplink transmissions from the UE to the BS to avoid using the identified PRBs includes transmitting an acknowledgment message (ACK) to the UE to prevent an uplink re-transmission from the UE.

32. The method of claim 29, wherein at least one of the first RAT comprises Global Systems for Mobile Communications (GSM) or CDMA2000 1×RTT, or the second RAT comprises long-term evolution (LTE).

33. The method of claim 29, wherein at least one of the first RAT comprises long-term evolution (LTE), or the second RAT comprises Global Systems for Mobile Communications (GSM) or CDMA2000 1×RTT.

34. The method of claim 29, wherein the identifying comprises predicting one or more frequencies used by the first RAT serving the UE based on neighbor frequency lists and a UE type.

35. The method of claim 30, wherein the scheduling comprises at least one of:
scheduling uplink transmissions from the UE on PRBs not corresponding to one or more frequency ranges on which UL transmission by the UE in the first RAT interfere or potentially interfere with downlink receiving from either the second RAT or the first RAT; or
initiating a handover to a RAT or frequency on which communications by the UE in the first RAT do not interfere with communications in the second RAT.

36. A method, apparatus, system, computer program product, and processing system as substantially described herein with reference to and as illustrated by the accompanying drawings.
